(19) United States
(12) Patent Application Publication
(10) Pub. No.: US 2009/0091532 A1
(43) Pub. Date: Apr. 9, 2009

(54) REMOTELY CONTROLLING COMPUTER OUTPUT DISPLAYED ON A SCREEN USING A SINGLE HAND-HELD DEVICE

(75) Inventor: Hugh Edward Hockett, Raleigh, NC (US)

Correspondence Address: IBM CORP. (WSM);c/o WINSTEAD SECHREST & MINICK P.C., P.O. BOX 50784, DALLAS, TX, 75201, US

(73) Assignee: International Business Machines Corporation, Armonk, NY (US)

(21) Appl. No.: 11/867,335

(22) Filed: Oct. 4, 2007

(51) Int. Cl. G06F 3/033

(52) U.S. Cl. 345/158

(57) ABSTRACT

A method, hand-held device and system for remotely controlling computer output displayed on a screen. A single hand-held device is used to remotely control the output of the computer displayed on a screen, where the hand-held device includes both a laser pointer and a camera. The camera is aligned with the laser pointer in such a manner as to be able to capture an image on the screen where the light is projected from the laser pointer. Image matching software may then be used to match the captured image with the image of the output of the computer displayed on the screen. User input (e.g., left-click action) may be received which is then used by the computer to perform that action in connection with the location (e.g., print icon) on the image displayed on the screen by the computer that corresponds to the position the point of light is projecting.

### TECHNICAL FIELD

The present invention relates to computer presentation systems, and more particularly to remotely controlling the output of the computer displayed on a screen using a single hand-held device.

### BACKGROUND INFORMATION

Computers are increasingly being used for graphical presentations and/or demonstrations where the output of these computers is displayed on a large screen in front of an audience. Many presentations, such as slide shows and the like, require relatively simple control of the computer during the actual presentation. Commands which advance or reverse slides or initiate a display sequence require only a basic user interface or remote control to communicate with the computer. However, more sophisticated presentations or demonstrations, such as used for software user training or promotion, require a more sophisticated interface or remote control to effectively operate the computer. Conventional strategies require the presenter to either remain within close proximity of the computer to operate the keyboard and/or selection device (e.g., mouse, track ball) or have an assistant perform the required operations. Such strategies are unsuitable for sophisticated presentations or demonstrations. Hence, there is a need to remotely control the computer output displayed on a screen for sophisticated presentations or demonstrations.

One method in controlling the computer output displayed on a screen is by having a laptop computer connected to both a video projector and a video camera. The video projector projects an image of the computer output onto a screen. A user with a pointing device, such as an optical pointer, generates an external cursor which is superimposed on the image on the screen which is outputted by the computer. The camera captures an image including at least a substantial portion of the image generated by the projector and the generated external cursor. The computer processes the captured image to determine the position of the external cursor and generates an appropriate command or commands based on the position of the external cursor. For example, based on the position of the external cursor, the computer may generate position-dependent commands, such as a “left-click” or “right-click” command. For instance, if the pointing device generated an external cursor over the “new blank document” icon in Microsoft™ Word, then the computer may generate a “left-click” command thereby causing Microsoft™ Word to open a new blank document on the computer, which is outputted to the screen via the projector.

However, the above-method requires a separate camera peripheral coupled to the computer, where the camera needs to be mounted and pointed at the screen. Further, the camera may detect the projections of light from other optical pointers in the audience thereby possibly causing the computer to generate a command not intended by the presenter. Furthermore, the camera may not be able to determine the difference between the presenter drawing on the screen or attempting to perform an action (e.g., select a button).

As a result, there is a need in the art for remotely controlling the output of the computer displayed on a screen using a single hand-held device without requiring a separate camera peripheral, where projections of light from other optical pointers in the audience will not be detected and where the presenter's actions will be more correctly interpreted.

### SUMMARY

The problems outlined above may at least in part be solved in some embodiments by a single hand-held device configured to remotely control the output of the computer displayed on a screen, where the hand-held device includes both a laser pointer and a camera. The camera is aligned with the laser pointer in such a manner as to be able to capture an image on a screen where the light is projected from the laser pointer of the hand-held device and not capture any image based on light projected from other laser pointers. Image matching software may then be used to match the captured image (i.e., the image on the screen where the light is projected from the laser pointer) with the image of the output of the computer displayed on the screen. A location (e.g., print icon) on the image displayed on the screen by the computer may then be determined which corresponds to the position the point of light is projecting. User input (e.g., left-click command) may be received by the hand-held device which is then used by the computer to perform that action (e.g., left-click command) in connection with the location on the image (e.g., print icon) displayed on the screen that corresponds to where the point of light is pointing. In this manner, the output of the computer displayed on a screen may be remotely controlled using a single hand-held device without requiring a separate camera peripheral, where projections of light from other optical pointers in the audience will not be detected and where the presenter's actions will be more correctly interpreted.

In one embodiment of the present invention, a hand-held device comprises a laser pointer configured to project a point of light at a position on a screen. The hand-held device further comprises a camera configured to capture an image on the screen, where the captured image comprises an image on the screen located at the position the point of light is projected. Additionally, the hand-held device comprises a memory unit for storing a computer program for remotely controlling computer output displayed on the screen. Further, the hand-held device comprises a processor coupled to the laser pointer, the camera and the memory unit, where the processor, responsive to the computer program, comprises circuitry for receiving an image displayed on the screen by a computer through a projector. Further, the processor comprises circuitry for matching the captured image with the image displayed on the screen by the computer through the projector. Additionally, the processor comprises circuitry for determining a location on the image displayed on the screen by the computer through the projector that corresponds to the position the point of light is projected. Furthermore, the processor comprises circuitry for receiving user input to perform an action. In addition, the processor comprises circuitry for transmitting to the computer the requested action to be performed in connection with the position the point of light is projected.

In another embodiment of the present invention, a method for remotely controlling computer output displayed on a screen comprises the step of capturing an image on the screen via a camera in a single hand-held device, where the captured image comprises an image on the screen located at a position a point of light is projected onto the screen by a laser pointer in the single hand-held device. The method further comprises matching the captured image with an image displayed on the screen by a computer through a projector. Furthermore, the method comprises determining a location on the image displayed on the screen by the computer through the projector that corresponds to the position the point of light is projected. Additionally, the method comprises receiving user input to perform an action. Further, the method comprises performing the requested action in connection with the position the point of light is projected.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates a presentation system for remotely controlling the computer output displayed on a screen in accordance with an embodiment of the present invention;

FIG. 2 illustrates the internal hardware configuration of the hand-held device in accordance with an embodiment of the present invention;

FIG. 3 illustrates the locations of the laser pointer and the camera in hand-held device in accordance with an embodiment of the present invention;

FIG. 4 illustrates the external layout of the hand-held device in accordance with an embodiment of the present invention;

FIG. 5 illustrates the hardware configuration of the computer used in the presentation system in accordance with an embodiment of the present invention;

FIG. 6 is a flowchart of a method for remotely controlling the output of the computer displayed on a screen in accordance with an embodiment of the present invention; and

FIG. 7 is a flowchart of an alternative method for remotely controlling the output of the computer displayed on a screen in accordance with an embodiment of the present invention.

### DETAILED DESCRIPTION

The present invention comprises a method, hand-held device and system for remotely controlling computer output displayed on a screen. In one embodiment of the present invention, an image of the output of a computer is displayed on a screen by a projector. A single hand-held device is used by the presenter of the presentation/demonstration to remotely control the output of the computer, where the single hand-held device includes both a laser pointer and a camera. The camera is aligned with the laser pointer in such a manner as to be able to capture an image on a screen where the light is projected from the laser pointer of the hand-held device and not capture any image based on light projected from other laser pointers. Image matching software may then be used to match the captured image (i.e., the image on the screen where the light is projected from the laser pointer) with the image of the output of the computer displayed on the screen. A location (e.g., print icon) on the image displayed on the screen by the computer may then be determined which corresponds to the position the point of light is projecting. User input (e.g., left-click command) may be received by the hand-held device which is then used by the computer to perform that action (e.g., left-click command) in connection with the location on the image (e.g., print icon) displayed on the screen that corresponds to where the point of light is pointing. In this manner, the output of the computer displayed on a screen may be remotely controlled using a single hand-held device without requiring a separate camera peripheral, where projections of light from other optical pointers in the audience will not be detected and where the presenter's actions will be more correctly interpreted.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

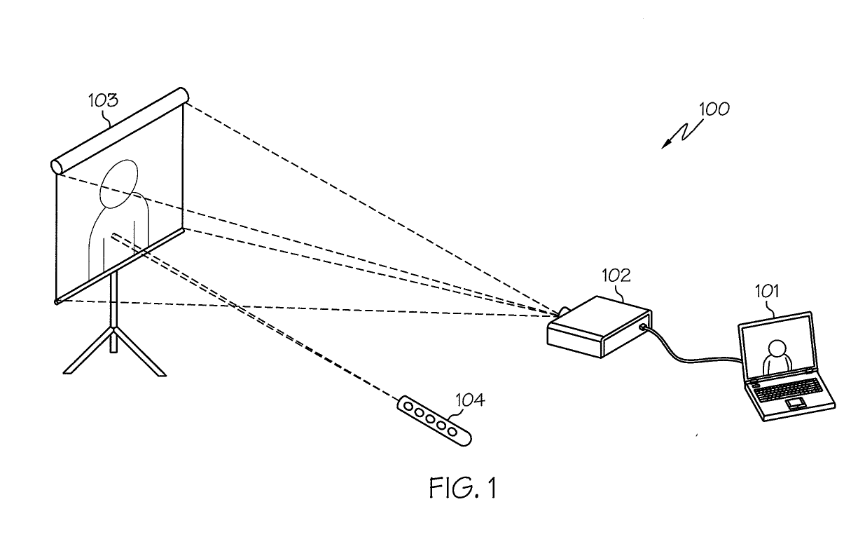

### FIG. 1—Presentation System

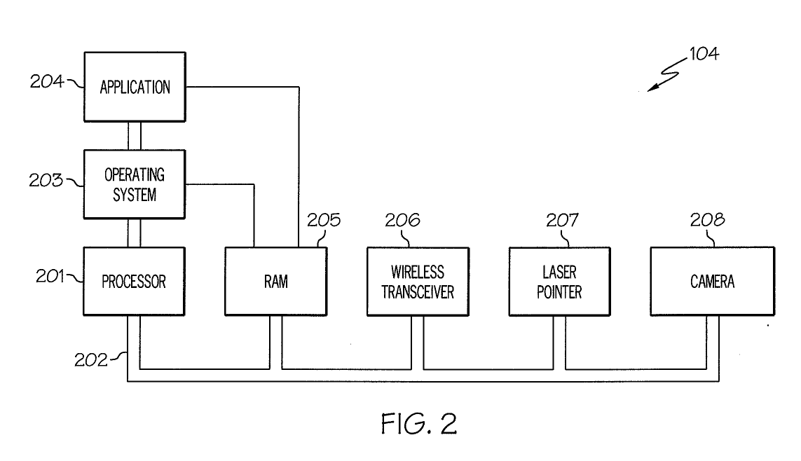

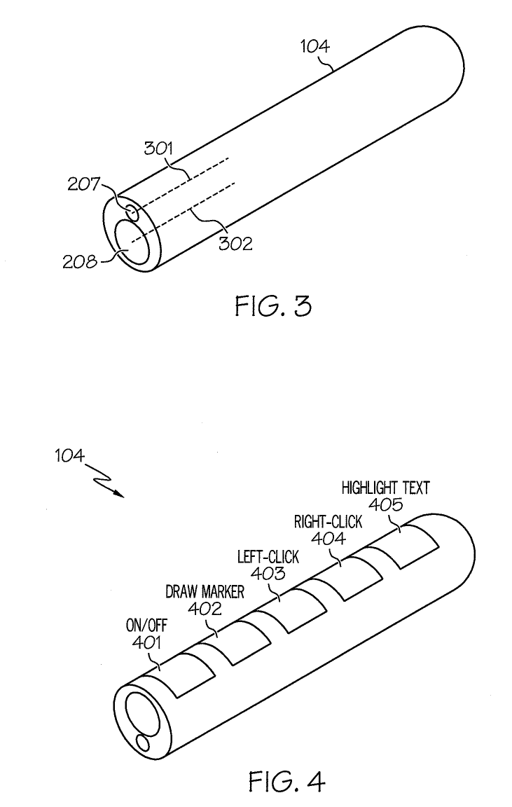

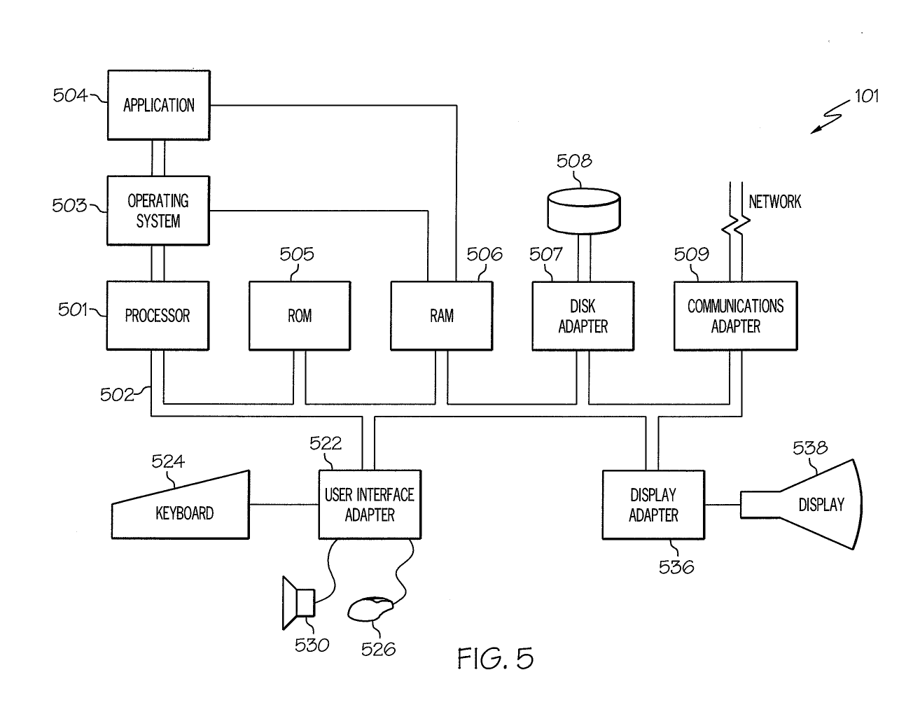

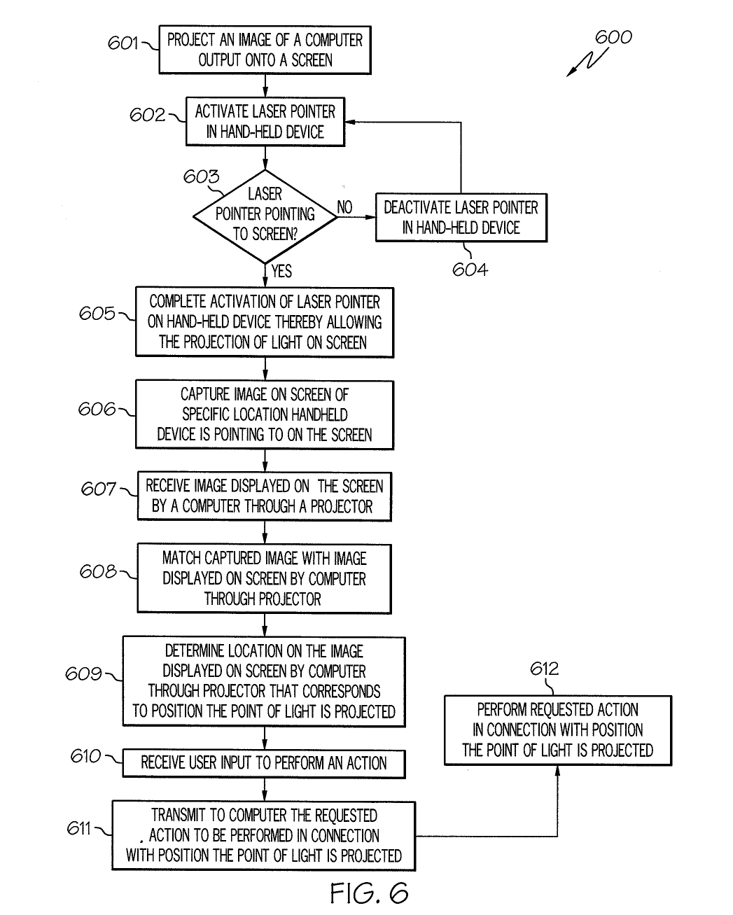

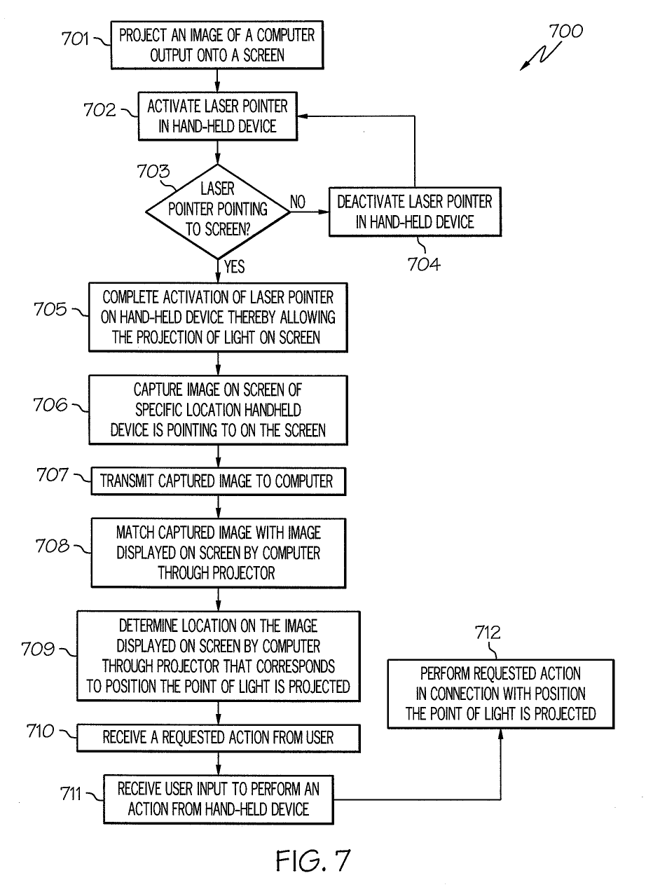

FIG. 1 illustrates an embodiment of the present invention of a presentation system 100 for remotely controlling the computer output displayed on a screen using a single hand-held device in accordance with an embodiment of the present invention. Referring to FIG. 1, presentation system 100 includes a laptop computer 101 connected to a video projector 102. A description of the hardware configuration of computer 101 is provided further below in connection with FIG. 5. Video projector 102 is configured to project an image (indicated by dashed lines flowing from video projector 102) of the output of computer 101 onto a projection screen 103. Presentation system 100 may further include a single hand-held device 104 that includes a laser pointer (not shown) used to project a light (indicated by dashed lines flowing from hand-held device 104) at a location on screen 103. In one embodiment, hand-held device 104 is shaped in the form of a pen. Further, hand-held device 104 may, in addition to being used in connection with presentations, be used as a general purpose input device, such as a mouse. Hand-held device 104 may include other components, such as a camera (not shown) and a wireless transceiver (not shown) used in connection with remotely controlling the output of computer 101 as discussed further below in connection with FIGS. 6-7. Further, a description of the internal hardware configuration of hand-held device 104 is discussed further below in connection with FIG. 2. Additionally, a description of the orientation of the laser pointer and camera in hand-held device 104 is discussed further below in connection with FIG. 3. Furthermore, a description of the external layout of hand-held device 104 is discussed further below in connection with FIG. 4. Presentation system 100 depicted in FIG. 1 is illustrative and is not to be limited in scope to any one particular embodiment.

### FIG. 2—Internal Hardware Configuration of Hand-Held Device

FIG. 2 illustrates an embodiment of the internal hardware configuration of hand-held device 104 (FIG. 1) which is representative of a hardware environment for practicing the present invention. Hand-held device 104 may have a processor 201 coupled to various other components by system bus 202. An operating system 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, a program for controlling the output of computer 101 (FIG. 1) displayed on screen 103 (FIG. 1), as discussed further below in association with FIG. 6. In one embodiment, such a program includes image matching software used for matching an image captured by a camera of hand-held device 104 with an image projected onto screen 103 by computer 101 as discussed further below in connection with FIG. 6.

Referring to FIG. 2, Random Access Memory (RAM) 205 may be coupled system bus 202. It should be noted that software components including operating system 203 and application 204 may be loaded into RAM 205, which may be hand-held device's 104 main memory for execution.

Hand-held device 104 may further include a wireless transceiver 206, a laser pointer 207 and a camera 208 coupled to bus 202. Wireless transceiver 206 allows communication to occur between computer system 101 and hand-held device 104. In the embodiment in which application 204 includes image matching software, hand-held device 104 receives from computer 101 an image displayed on screen 103 by computer 101 through projector 102 via wireless transceiver 206. Further, in such an embodiment, hand-held device 104 transmits to computer 101 an action requested by the user of hand-held device 104 to be performed in connection with the position of the light projected on screen 103 via wireless transceiver 206. A more detail description of these functions will be discussed further below in connection with FIG. 6.

In an alternative embodiment, the image matching software may reside in computer 101 (discussed further below in connection with FIG. 5) instead of residing in hand-held device 104. In such an embodiment, hand-held device 104 transmits to computer 101 the image captured by camera 208 as well as transmits to computer 101 an action requested by the user of hand-held device 104 to be performed in connection with the position of the light projected on screen 103 via wireless transceiver 206. A more detail description of these functions will be discussed further below in connection with FIG. 7.

Referring to FIG. 2, in conjunction with FIG. 1, as discussed above, hand-held device 104 includes laser pointer 207. Laser pointer 207 is configured to project a point of light, such as on screen 103. In one embodiment, laser pointer 207 is activated automatically if hand-held device 104 is pointing to screen 103. Hand-held device 104 may be determined to be pointing to screen 103 based on the image captured by camera 208. A more detail discussion of camera 208 is provided below. Alternatively, laser pointer 207 may be activated by pressing an activation button (e.g., on/off button) or any button on hand-held device 104 half-way. Upon activating laser pointer 207, application 204 of hand-held device 104 may deactivate laser pointer 207 if hand-held device 104 is not pointing to screen 103. A more detail discussion of the exterior layout of hand-held device 104, including the buttons of hand-held device 104, is provided below in connection with FIG. 3.

Camera 208 of hand-held device 104 is configured to capture an image on screen 103 where the captured image includes the image on screen 103 located at the position the point of light is projected by laser pointer 207. For example, if laser pointer 207 is pointing to an icon (e.g., underline icon) on screen 103, then camera 208 captures an image on screen 103 that includes the underline icon. Laser pointer 207 and camera 208 may be located on the same axis to eliminate positional error. That is, laser pointer 207 and camera 208 may be located in parallel axes as illustrated in FIG. 3. FIG. 3 illustrates the locations of laser pointer 207 and camera 208 being on separate but parallel axes in accordance with an embodiment of the present invention. Referring to FIG. 3, in connection with FIG. 2, laser pointer 207 is located on axis 301; whereas, camera 208 is located on axis 302. Since axes 301, 302 are parallel to one another, camera 208 is able to obtain an accurate location of the point of light projected onto screen 103 by laser pointer 207. Furthermore, laser pointer 207 and camera 208 may be separated by a fixed distance (e.g., ½ inch) which may be taken into consideration (e.g., subtracted) when calculating the position of the point of light projected onto screen 103 by laser pointer 207. Additionally, since laser pointer 207 and camera 208 are aligned in such a manner, camera 208 will not detect projections of light from other optical pointers, such as from an audience.

It is noted that even though the following discusses camera 208 capturing an image on one particular projection screen that camera 208 can capture an image from any number of screens (e.g., two large projection screens, a television monitor) provided that the image matching software, discussed herein, can match the captured image with the image displayed on that screen by computer 101.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As discussed above, hand-held device 104 may include several buttons. These buttons may be used by the user of hand-held device 104 to select various actions to be performed as discussed below in connection with FIG. 4.

### FIG. 4—External Layout of Hand-Held Device

FIG. 4 is an embodiment of the present invention of the external layout of hand-held device 104 (FIGS. 1-2). Referring to FIG. 4, in connection with FIGS. 1-2, hand-held device 104 may include several buttons used for indicating to computer 101 to perform a designated action. For example, hand-held device 104 may include an on/off button 401 configured to activate/deactivate hand-held device 104, including laser pointer 207. Hand-held device 104 may further include a “draw marker” button 402 configured to activate the function of hand-held device 104 drawing on screen 103 using laser pointer 207. Additionally, hand-held device 104 may include a left-click button 403 and a right-click button 404 which will be used to instruct computer 101 to perform the left-click and right-click functions, respectively, of a mouse. Further, hand-held device 104 may include a highlight text button 405 used to activate the function of highlighting text that appears on screen 103. The external layout of hand-held device 104 depicted in FIG. 4 is illustrative and is not to be limited in scope to any one particular embodiment. For example, hand-held device may include any number of buttons and may include additional features or fewer features than depicted in FIG. 4.

As discussed above, laser pointer 207 may be activated in a number of ways. For instance, laser pointer 207 may be activated by the user of hand-held device 104 pressing the on/off button 104 to activate hand-held device 104. In another embodiment, laser pointer 207 may be activated by the user of hand-held device 104 pressing down half-way a button 401-405 of hand-held device 104. Upon activating laser pointer 207, laser pointer 207 may be deactivated by the program 204 of hand-held device 104 if the projected light from laser pointer 207 is not pointing to screen 103 (e.g., pointing to audience instead of pointing to screen 103) as determined by camera 208. If, however, laser pointer 207 is pointing to screen 103, then, light is allowed to be projected by laser pointer 207 onto screen 103. In an alternative embodiment, laser pointer 207 may be activated automatically (assuming hand-held device 104 is already activated) upon camera 208 detecting an image on screen 103.

As discussed above, the image matching software may be stored in computer 101. A description of the hardware configuration of computer 101, including the storing of the image matching software in computer 101, is provided below in connection with FIG. 5.

### FIG. 5—Computer System

FIG. 5 illustrates an embodiment of a hardware configuration of a computer system 101 (FIG. 1) which is representative of a hardware environment for practicing the present invention. Computer system 101 may have a processor 501 coupled to various other components by system bus 502. An operating system 503 may run on processor 501 and provide control and coordinate the functions of the various components of FIG. 5. An application 504 in accordance with the principles of the present invention may run in conjunction with operating system 503 and provide calls to operating system 503 where the calls implement the various functions or services to be performed by application 504. Application 504 may include, for example, image matching software used for matching the image captured by camera 208 of hand-held device 104 with an image projected onto screen 103 by computer 101 as discussed further below in connection with FIG. 7. Application 504 may further include, for example, the program for receiving various information (e.g., captured image, user input) from hand-held device 104 and performing the user requested action as discussed further below in connection with FIG. 7.

Referring to FIG. 5, Read-Only Memory (ROM) 505 may be coupled to system bus 502 and include a basic input/output system (“BIOS”) that controls certain basic functions of computer system 101. Random Access Memory (RAM) 506 and disk adapter 507 may also be coupled to system bus 502. It should be noted that software components including operating system 503 and application 504 may be loaded into RAM 506, which may be computer system's 101 main memory for execution. Disk adapter 507 may be an integrated drive electronics (“IDE”) adapter that communicates with a disk unit 508, e.g., disk drive. It is noted that the programs mentioned above may reside in disk unit 508 or in application 504.

Referring to FIG. 5, computer system 101 may further include a communications adapter 509 coupled to bus 502. Communications adapter 509 may interconnect bus 502 with an outside network (not shown) enabling computer system 101 to communicate with other devices, such as hand-held device 104.

I/O devices may also be connected to computer system 101 via a user interface adapter 522 and a display adapter 536. Keyboard 524, mouse 526 and speaker 530 may all be interconnected to bus 502 through user interface adapter 522. Data may be inputted to computer system 101 through any of these devices. A display monitor 538 may be connected to system bus 502 by display adapter 536. In this manner, a user is capable of inputting to computer system 101 through keyboard 524 or mouse 526 and receiving output from computer system 101 via display 538 or speaker 530.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As stated in the Background Information section, computer output displayed on a screen was remotely controlled via a separate camera peripheral coupled to the computer, where the camera needed to be mounted and pointed at the screen. Further, the camera may detect the projections of light from other optical pointers in the audience thereby possibly causing the computer to generate a command not intended by the presenter. Furthermore, the camera may not be able to determine the difference between the presenter drawing on the screen or attempting to perform an action (e.g., select a button). As a result, there is a need in the art for remotely controlling the output of the computer displayed on a screen using a single hand-held device without requiring a separate camera peripheral, where projections of light from other optical pointers in the audience will not be detected and where the presenter's actions will be more correctly interpreted. As discussed herein, hand-held device 104 (FIGS. 1-4) is a single device that does not require a separate camera peripheral and does not detect projections of light from other optical pointers. Further, as discussed herein, hand-held device 104 correctly interprets the user's actions. Hand-held device 104 remotely controls the output of computer 101 where the image matching software resides in hand-held device 104 or in computer 101 as discussed below in connection with FIGS. 6 and 7, respectively. FIG. 6 is a flowchart of a method for remotely controlling the output of computer 101 displayed on screen 103 (FIG. 1) where the image matching software resides in hand-held device 104. FIG. 7 is a flowchart of a method for remotely controlling the output of computer 101 displayed on screen 103 where the image matching software resides in computer 101.

### FIG. 6—Method for Remotely Controlling the Output of Computer Displayed on Screen

FIG. 6 is a method 600 for remotely controlling the output of computer 101 (FIGS. 1 and 5) displayed on screen 103 (FIG. 1) where the image matching software resides in hand-held device 104 (FIGS. 1-4) in accordance with an embodiment of the present invention.

Referring to FIG. 6, in conjunction with FIGS. 1-2, 4 and 5, in step 601, projector 102 projects an image of the output of computer 101 onto screen 103.

In step 602, laser pointer 207 in hand-held device 104 is activated. There are various ways of activating laser pointer 207, including automatically activating laser pointer 207 upon camera 208 detecting an image on screen 103, which were discussed above and will not be reiterated herein for the sake of brevity.

In step 603, hand-held device 104 determines whether laser pointer 207 is pointing to screen 103. In one embodiment, camera 208 determines whether laser pointer 207 is pointing to screen 103 based on an image captured by camera 208. If the image includes the background of a screen, then, hand-held device 101 determines that laser pointer 207 is pointing to screen 103. If, however, the background of the image captured by camera 208 does not include a screen, then hand-held 101 concludes that laser pointer 207 is pointing to something other than screen 103 (e.g., audience).

If hand-held device 104 determines that laser pointer 207 is not pointing to screen 103, then, in step 604, hand-held device 104 deactivates laser pointer 207. Laser pointer 207 may at a later time be activated in step 602.

If, however, hand-held device 104 determines that laser pointer 207 is pointing to screen 103, then, in step 605, hand-held device 104 completes the activation of laser pointer 207 by allowing the projection of light by laser pointer 207 onto screen 103.

In step 606, camera 208 captures the image on screen 103 including the image of the location where hand-held device 104 is pointing to on screen 103. That is, camera 208 captures the image on screen 103 including the image of the location where the point of light is projected by laser pointer 207.

In step 607, hand-held device 104 receives via wireless transceiver 206 the image displayed on screen 103 by computer 101 through projector 102.

In step 608, hand-held device 104 matches the image captured in step 606 with the image received in step 607 (i.e., the image displayed on screen 103 by computer 101 through projector 102). In one embodiment, the image matching software on hand-held device 104 searches the image captured in step 606 for all or part of the image received in step 607 (i.e., the image displayed on screen 103 by computer 101 through projector 102).

In step 609, hand-held device 104 determines the location on the image displayed on screen 103 by computer 101 that corresponds to the position the point of light is projected.

In step 610, hand-held device 104 receives input to perform an action from the user of hand-held device 104. For example, the user of hand-held device 104 may select left-click button 403 on hand-held device 104.

In step 611, hand-held device 104 transmits via wireless transceiver 206 to computer 101 the requested action to be performed in connection with the position the point of light is projected onto screen 103. That is, held device 104 transmits via wireless transceiver 206 to computer 101 the requested action to be performed at the location determined in step 609. For example, if the point of light projected from laser pointer 207 points to the print icon, then hand-held device transmits the action requested by the user (e.g., left-click action) to be performed at the print icon.

In step 612, computer 101 performs the requested action in connection with the position the point of light is projected. Referring to the previous example, computer 101 would perform the action of a left-click function at the print icon (where the light is projected by laser pointer 207) thereby causing the page to print.

Method 600 may include other and/or additional steps that, for clarity, are not depicted. Further, method 600 may be executed in a different order presented and that the order presented in the discussion of FIG. 6 is illustrative. Additionally, certain steps in method 600 may be executed in a substantially simultaneous manner or may be omitted.

As discussed above, in an alternative embodiment, the image matching software may reside in computer 101. A discussion of a method for remotely controlling the output of computer 101 displayed on screen 103 where the image matching software resides in computer 101 is provided below in connection with FIG. 7.

### FIG. 7—Alternative Method for Controlling the Output of Computer Displayed on Screen

FIG. 7 is a method 700 for remotely controlling the output of computer 101 (FIGS. 1 and 5) displayed on screen 103 (FIG. 1) where the image matching software resides in computer 101 in accordance with an embodiment of the present invention.

Referring to FIG. 7, in conjunction with FIGS. 1-2, 4 and 5, in step 701, projector 102 projects an image of the output of computer 101 onto screen 103.

In step 702, laser pointer 207 in hand-held device 104 is activated. There are various ways of activating laser pointer 207, including automatically activating laser pointer 207 upon camera 208 detecting an image on screen 103, which were discussed above and will not be reiterated herein for the sake of brevity.

In step 703, hand-held device 104 determines whether laser pointer 207 is pointing to screen 103. In one embodiment, camera 208 determines whether laser pointer 207 is pointing to screen 103 based on an image captured by camera 208. If the image includes the background of a screen, then, hand-held device 101 determines that laser pointer 207 is pointing to screen 103. If, however, the background of the image captured by camera 208 does not include a screen, then hand-held 101 concludes that laser pointer 207 is pointing to something other than screen 103 (e.g., audience).

If hand-held device 104 determines that laser pointer 207 is not pointing to screen 103, then, in step 704, hand-held device 104 deactivates laser pointer 207. Laser pointer 207 may at a later time be activated in step 702.

If, however, hand-held device 104 determines that laser pointer 207 is pointing to screen 103, then, in step 705, hand-held device 104 completes the activation of laser pointer 207 by allowing the projection of light by laser pointer 207 onto screen 103.

In step 706, camera 208 captures the image on screen 103 including the image of the location where hand-held device 104 is pointing to on screen 103. That is, camera 208 captures the image on screen 103 including the image of the location where the point of light is projected by laser pointer 207.

In step 707, hand-held device 104 transmits the captured image (image captured by camera in step 706) to computer 101 via wireless transceiver 206.

In step 708, computer 101 matches the image displayed on screen 103 by computer 101 through projector 102 with the image received in step 707 (i.e., the image captured by camera in step 706). In one embodiment, the image matching software on computer 101 searches the image received in step 707 (i.e., the image captured by camera in step 706) for all or part of the image displayed on screen 103 by computer 101 through projector 102.

In step 709, computer 101 determines the location on the image displayed on screen 103 by computer 101 that corresponds to the position the point of light is projected.

In step 710, hand-held device 104 receives input to perform an action from the user of hand-held device 104. For example, the user of hand-held device 104 may select left-click button 403 on hand-held device 104.

In step 711, computer 101 receives the requested action to be performed in connection with the position the point of light is projected onto screen 103 from hand-held device 104 via wireless transceiver 206. That is, held device 104 transmits via wireless transceiver 206 to computer 101 the requested action to be performed at the location determined in step 709. For example, if the point of light projected from laser pointer 207 points to the print icon, then hand-held device transmits the action requested by the user (e.g., left-click action) to be performed at the print icon.

In step 712, computer 101 performs the requested action in connection with the position the point of light is projected. Referring to the previous example, computer 101 would perform the action of a left-click function at the print icon (where the light is projected by laser pointer 207) thereby causing the page to print.

Method 700 may include other and/or additional steps that, for clarity, are not depicted. Further, method 700 may be executed in a different order presented and that the order presented in the discussion of FIG. 7 is illustrative. Additionally, certain steps in method 700 may be executed in a substantially simultaneous manner or may be omitted.

Although the method, hand-held device, and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for remotely controlling computer output displayed on a screen comprising the steps of:
capturing an image on said screen via a camera in a single hand-held device, wherein said captured image comprises an image on said screen located at a position a point of light is projected onto said screen by a pointer in said single hand-held device;
matching said captured image with an image displayed on said screen by a computer through a projector;
determining a location on said image displayed on said screen by said computer through said projector that corresponds to said position said point of light is projected;
receiving user input to perform an action; and
performing said requested action in connection with said position said point of light is projected.

2. The method as recited in claim 1 further comprising the step of:
activating said pointer in said single hand-held device.

3. The method as recited in claim 2, wherein said pointer in said single hand-held device is activated by half-pressing a button on said single hand-held device.

4. The method as recited in claim 2 further comprising the step of:
deactivating said pointer in said single hand-held device if said single hand-held device is not pointing to said screen.

5. The method as recited in claim 1 further comprising the step of:
activating said pointer in said single hand-held device automatically if said hand-held device is pointing to said screen.

6. The method as recited in claim 1, wherein said pointer and said camera are aligned in such a manner as to eliminate positional error.

7. The method as recited in claim 1, wherein said single hand-held device is shaped in a form of a pen.

8. A hand-held device, comprising:
a pointer configured to project a point of light at a position on a screen;
a camera configured to capture an image on said screen, wherein said captured image comprises an image on said screen located at said position said point of light is projected;
a memory unit for storing a computer program for remotely controlling computer output displayed on said screen; and
a processor coupled to said pointer, said camera and said memory unit, wherein said processor, responsive to said computer program, comprises:
circuitry for receiving an image displayed on said screen by a computer through a projector;
circuitry for matching said captured image with said image displayed on said screen by said computer through said projector;
circuitry for determining a location on said image displayed on said screen by said computer through said projector that corresponds to said position said point of light is projected;
circuitry for receiving user input to perform an action; and
circuitry for transmitting to said computer said requested action to be performed in connection with said position said point of light is projected.

9. The hand-held device as recited in claim 8 further comprises:
a wireless transceiver coupled to said processor, wherein said requested action to be performed in connection with said position said point of light is projected is transmitted to said computer via said wireless transceiver.

10. The hand-held device as recited in claim 8 further comprises:
a plurality of buttons configured to perform one or more of the following functions: draw, a left-click, a right-click, and highlight.

11. The hand-held device as recited in claim 8, wherein said pointer is activated by half-pressing a button on said single hand-held device.

12. The hand-held device as recited in claim 8, wherein said pointer is activated automatically if said hand-held device is pointing to said screen.

13. The hand-held device as recited in claim 8, wherein said pointer and said camera are aligned in such a manner as to eliminate positional error.

14. The hand-held device as recited in claim 8, wherein said hand-held device is shaped in a form of a pen.

15. A system, comprising:
a computer;
a projector coupled said computer, wherein said projector is configured to project an image of an output of said computer onto a screen; and
a hand-held device remotely connected to said computer, wherein said hand-held device comprises:
a pointer configured to project a point of light at a position on a screen;
a camera configured to capture an image on said screen, wherein said captured image comprises an image on said screen located at said position said point of light is projected; and
a wireless transceiver coupled to said pointer and said camera, wherein said wireless transceiver is configured to transmit said captured image to said computer, wherein said wireless transceiver is further configured to transmit user input to perform an action to said computer;
wherein said computer comprises:
a memory unit for storing a computer program for performing image matching; and
a processor coupled to said memory unit, wherein said processor, responsive to said computer program, comprises:
circuitry for receiving said captured image;
circuitry for matching said captured image with said image displayed on said screen by said computer through said projector;
circuitry for determining a location on said image displayed on said screen by said computer through said projector that corresponds to said position said point of light is projected;
circuitry for receiving said user input to perform said action; and
circuitry for performing said requested action in connection with said position said point of light is projected.

16. The system as recited in claim 15, wherein said hand-held device further comprises:
a plurality of buttons configured to perform one or more of the following functions: draw, a left-click, a right-click, and highlight.

17. The system as recited in claim 15, wherein said pointer is activated by half-pressing a button on said single hand-held device.

18. The system as recited in claim 15, wherein said pointer is activated automatically if said hand-held device is pointing to said screen.

19. The system as recited in claim 15, wherein said pointer and said camera are aligned in such a manner as to eliminate positional error.

20. The system as recited in claim 15, wherein said hand-held device is shaped in a form of a pen.
